(19) United States
(12) Patent Application Publication
(10) Pub. No.: US 2024/0189873 A1
(43) Pub. Date: Jun. 13, 2024

(54) JET EXHAUST COLLECTOR

(71) Applicant: Thomas Michael Kuhl, Rosemount, MN (US)

(72) Inventor: Thomas Michael Kuhl, Rosemount, MN (US)

(21) Appl. No.: 18/411,322

(22) Filed: Jan. 12, 2024

Related U.S. Application Data
(63) Continuation of application No. PCT/IB22/55915, filed on Jun. 25, 2022.
(60) Provisional application No. 63/222,057, filed on Jul. 15, 2021.

(51) Int. Cl. B08B 15/00; B64F 1/26

(52) U.S. Cl. CPC B08B 15/00; B64F 1/26

(57) ABSTRACT

A jet exhaust capturing and containing apparatus for collecting ultrafine particles (UFPs) and gaseous exhaust exiting a jet engine or APU nozzle while in operation near an airport facility where an aircraft is in motion, or at stop, around any part of an airport property where an aircraft may taxi, stop, or otherwise be in motion.

### CROSS REFERENCE TO RELATED APPLICATIONS

This application is a By-pass Continuation application which claims priority under 35 U.S.C. § 119 to PCT International Application No. PCT/IB2022/055915, filed Jul. 14, 2022, and U.S. Provisional Patent Application Ser. No. 63/222,057, filed Jul. 15, 2021. The PCT International application and Provisional patent application are each hereby incorporated by reference herein in their entireties, including without limitation: the specification, claims, and abstract, as well as any figures, tables, appendices, or drawings thereof.

### FIELD OF THE INVENTION

This invention relates to jet exhaust and an apparatus to collect it.

### BACKGROUND OF THE INVENTION

Jet exhaust comprises a mixture of ultrafine particles (UFPs) and gaseous exhaust. The UFPs comprise a mixture that includes jet fuel, jet engine lubricants, jet engine metals, and organophosphates esters (OPEs). The gaseous exhaust comprises a temperature mixture at over 100 degrees F. (32 degrees C.) that includes volatile organic compounds (VOCs) mixed with air and water.

Jet exhaust has long been known as a problem in the aviation industry. Similar in composition to diesel exhaust which is classified as carcinogenic to humans by the International Agency for Research on Cancer (IARC), jet exhaust is known to contain at least one carcinogen, Benzene. In addition to being a threat to air quality outside airports and in surrounding communities, jet exhaust is a threat to the air quality inside airport facilities themselves. One study showed a 40-minute wait 100 meters downwind of the runway was equal to 240 minutes of exposure in an urban background environment away from the airport. Also, exposure during an entire average waiting period (including in the terminal building and airliner cabin) of a passenger was estimated to be equivalent to 11 hours of exposure to normal urban emissions.

Because jet engine systems are notoriously hard to start when “cold”, where allowed, many airlines keep one main engine in operation when their aircraft are in service in addition to using the auxiliary power units (APUs) with exhaust nozzles at the rear of the aircraft that create their own jet exhaust similar to that of jet engines.

Because jet exhaust does not burn completely while aircraft engines and APUs are in operation, the resulting ultrafine particles (UFPs) can be “sucked” into the HVAC systems of airport facilities near where jet engines and APUs are in use. This, at the very least, causes cosmetic damage to the adjacent airport facilities and possibly causing damage to the health of everyone within said airport facilities as it mixes with the air circulating within them.

There is a need for a device for capturing and containing jet exhaust, to significantly reduce jet exhaust exposure and its harmful results to persons and environments inside and outside airport facilities where jet engines or APUs are in operation.

### SUMMARY OF THE INVENTION

The invention is an apparatus to capture and contain jet exhaust to minimize the occurrence of adverse health effects from exposure to the exhaust within as well as outside airport facilities while a jet engine or APU is in operation, around any part of an airport property where an aircraft may taxi, stop, or otherwise be idling.

The invention comprises both an apparatus aspect and a method of using aspect. The apparatus aspect is a jet engine exhaust or APU exhaust capture and containing apparatus for collecting UFPs and gaseous exhaust exiting a jet engine or APU nozzle while in operation. Specifically, the invention is a jet exhaust capture and containing apparatus for collecting ultrafine particles and gaseous exhaust exiting a jet engine or jet auxiliary power unit nozzle along an axis while in operation. It comprises six elements, a catch basin, a chute, a container, a drain plug, a frame, and one or more wheels or casters. The catch basin comprises an adjustable intake orifice, a size sufficient to capture the ultrafine particles and gaseous exhaust, a diameter configured to allow the apparatus to be used behind a variety of jet engines or APUs, and an exit end. The chute comprises a first end connected to the exit of the catch basin, a size configured to efficiently transport all UFPs and gaseous exhaust exiting the jet engine or APU nozzle without clogging itself or otherwise disrupting the flow of the UFPs and gaseous exhaust and an adjustable exit end. The container comprises a front end connected to the exit end of the chute, a size configured to be sufficient to contain a predetermined amount of UFPs and gaseous exhaust for a predetermined or reasonable amount of time to allow the UFPs and gaseous exhaust to convert into a liquid slurry before needing to be emptied from the container, a material of construction, and an end. The drainage plug is configured to connect to the exit end of the container and be used for emptying and properly disposing or recycling of the liquid slurry. The frame is configured to support the container. The one or more wheels or casters are connected to the container and configured to provide mobility to transport the jet exhaust capture and containing apparatus to and from a jet engine or APU nozzle while the jet engine or auxiliary power unit is in operation.

The method aspect of using a jet exhaust capture and containing apparatus for collecting UFPs and gaseous exhaust exiting a jet engine or APU nozzle while the jet is in operation comprises four steps. The first step is providing a jet engine or APU in operation. The second step is providing a jet exhaust capture and containing apparatus as described above. The third step is collecting jet exhaust from the jet engine or auxiliary power unit in operation, converting it into a liquid slurry for storage in a safe and healthy manner. The fourth step is disposing of collected and converted liquid slurry in a safe and healthy manner.

Benefits are Several. The invention captures and contains dangerous jet emissions comprising UFPs and gaseous emissions before exposure to humans at airports. Some embodiments are configured to fit most if not all jet engines and APU nozzles. Some embodiments are configured to follow jet aircraft while moving about the airport before liftoff.

### BRIEF DESCRIPTION OF THE DRAWINGS

The following terms are used in this document:

“Auxiliary power units” or APUs means units attached to jet airplanes to keep the engine system warm enough for easy start-up of the jet engines, especially during cold temperatures below 32 degrees F.

“In operation” means obtaining or maintaining at least one main jet engine idling while the plane is resting or moving to a different location at an airport, in addition to using one or more APUs in preparation for eventual takeoff.

“Gaseous exhaust” means volatile organic compounds (VOCs), air, and water at a temperature at over 100 degrees F. (32 degrees C.).

“Jet exhaust” means ultrafine particles and gaseous exhaust and has an axis down the center of the exiting stream of exhaust.

“Ultrafine particles” or UFPs means a mixture of particles that includes jet fuel, jet engine lubricants, jet engine metals, and organophosphates esters (OPEs).

The invention will become more fully understood by the accompanying drawings, wherein like elements are represented by like reference characters that are given by way of illustration only and thus are not limitative of the example embodiments herein.

FIG. 1 is a side view of one potential embodiment of the apparatus.

FIG. 2 is a side view of the apparatus shown in FIG. 1 and a partial jet engine with jet engine exhaust.

FIG. 3 is a side view of the apparatus shown in FIG. 1 and the entire jet engine with part of a jet.

FIG. 4 is a side view of the apparatus shown in FIG. 1 and the entire jet.

FIG. 5 is a perspective view looking downward of the apparatus shown in FIG. 1 but without the container.

FIG. 6 are two views of the apparatus shown in FIG. 1, showing the front (A) and back (B) of the apparatus.

While the invention is amenable to various modifications and alternative forms, specifics thereof have been shown by example in the drawings and will be described in detail below. However, it is to be understood that the intention is not to limit the invention to the particular embodiments described. On the contrary, the invention is intended to cover all modifications, equivalents, and alternatives falling within the scope of the invention as defined by the appended claims.

### DETAILED DESCRIPTION OF SOME EMBODIMENTS OF THE INVENTION

Jet exhaust comprises a mixture of ultrafine particles (UFPs) and gaseous exhaust. The UFPs comprise a mixture that includes jet fuel, jet engine lubricants, jet engine metals, and organophosphates esters (OPEs). The gaseous exhaust comprises a temperature mixture at over 100 degrees F. (32 degrees C.) that includes volatile organic compounds (VOCs) mixed with air and water.

Jet exhaust has long been known as a problem in the aviation industry. Similar in composition to diesel exhaust which is classified as carcinogenic to humans by the International Agency for Research on Cancer (IARC), jet exhaust is known to contain at least one carcinogen, Benzene. In addition to being a threat to air quality outside airports and in surrounding communities, jet exhaust is a threat to the air quality inside airport facilities themselves. One study showed a 40-minute wait 100 meters downwind of the runway was equal to 240 minutes of exposure in an urban background environment away from the airport. Also, exposure during an entire average waiting period (including in the terminal building and airliner cabin) of a passenger was estimated to be equivalent to 11 hours of exposure to normal urban emissions.

Because jet engine systems are notoriously hard to start when “cold”, where allowed, many airlines keep one main engine in operation when their aircraft are in service in addition to using the auxiliary power units (APUs) with exhaust nozzles at the rear of the aircraft that create their own jet exhaust similar to that of jet engines.

Because jet exhaust does not burn completely while aircraft engines and APUs are in operation, the resulting ultrafine particles (UFPs) can be “sucked” into the heating, ventilating, and air conditioning systems of airport facilities near where jet engines and APUs are in use. This, at the very least, causes cosmetic damage to the adjacent airport facilities and possibly causing damage to the health of everyone within said airport facilities as it mixes with the air circulating within them. Particularly during cold months, dark jet exhaust residue can be seen on some airport ceilings near cooling vents before they are washed away or painted over, or both. Some air vents near airport restaurants or other food outlets at an airport. The residue that passes through the heating, ventilating, and air conditioning system from the jet exhaust from at least one jet in operation near a terminal is visible for a time.

The invention comprises both an apparatus aspect and a method of using aspect. The apparatus aspect is a jet engine exhaust or APU exhaust capture and containing apparatus for collecting UFPs and gaseous exhaust exiting a jet engine or APU nozzle while in operation. Specifically, the invention is a jet exhaust capture and containing apparatus for collecting ultrafine particles and gaseous exhaust exiting a jet engine or jet auxiliary power unit nozzle along an axis while in operation. It comprises five elements, a catch basin, a chute, a container, a drain plug, and one or more wheels or casters.

The catch basin comprises an adjustable intake orifice, a size sufficient to capture the ultrafine particles and gaseous exhaust, a diameter configured to allow the apparatus to be used behind a variety of jet engines or APUs, and an exit end.

In some embodiments, the adjustable intake orifice is configured to tilt up, down, right, or left up to 60 degrees about the axis of the jet exhaust under manual or motorized control.

In some embodiments, the catch basin further comprises a latching system within the catch basin allowing the invention to provide a secure seal to the jet engine or APU. The latching system should be sufficient in size to create a secure seal around a variety of jet engines or APU nozzles. One example is folding flaps. The latching system may connect to the jet engine or APU nozzle using suction from the fan, turbine, pump, or other such suction device or by magnetic or electromagnetic attraction. It may or may not be made of metal, plastic, carbon fiber, rubber, vinyl, nylon, or other such similar material. Finally, the latching system should be durable enough to operate in all weather conditions, including during rain, sleet, snow, and extreme cold or hot temperatures.

The chute comprises a first end connected to the exit of the catch basin, a size configured to efficiently transport all UFPs and gaseous exhaust exiting the jet engine or APU nozzle without clogging itself or otherwise disrupting the flow of the UFPs and gaseous exhaust and an adjustable exit end. The chute may or may not be rigid or flexible and may or may not be made of metal, plastic, carbon fiber, rubber, vinyl, nylon, or other such similar material. The chute may or may not be circular, square, rectangular, or of such similar shape.

In some embodiments, the chute is configured to rotate a full 360 degrees about the axis of the jet exhaust under manual or motorized control and lower as low as 0 degrees or raise as high as 160 degrees about the axis of the jet exhaust under manual or motorized control.

The container comprises a front end connected to the exit end of the chute, a size configured to be sufficient to contain a predetermined amount of UFPs and gaseous exhaust for a predetermined or reasonable amount of time to allow the UFPs and gaseous exhaust to convert into a liquid slurry before needing to be emptied from the container, a material of construction, and an end.

In some embodiments, the container is small or compact enough to allow the apparatus to be placed where needed. This is particularly true with jet engines exhausting near heating, ventilating and air conditioning systems.

In some embodiments, the container is large or open enough to contain all ultrafine units and gaseous exhaust exiting the jet engine or auxiliary power unit nozzle for a predetermined amount of time of at least 2 hours. In some embodiments, the time is at least 3 hours, in some at least 4 hours, in some at least 5 hours, and in some at least 6 hours.

In some embodiments, the material of construction of the container is strong enough to hold the catch basin, chute, and drain plug of the jet exhaust capture and containing apparatus when the container is empty or full of liquid slurry and while the jet exhaust capture and containment apparatus is in motion or still.

The drainage plug is configured to connect to the exit end of the container and be used for emptying and properly disposing or recycling of the liquid slurry.

The one or more wheels or casters in communication with the container and configured to provide mobility to transport the jet exhaust capture and containing apparatus to and from a jet engine or APU nozzle while the jet engine or auxiliary power unit is in operation. The communication may be a frame supporting the container and may or may not be driven with power and directed by an operator or automatically.

In some embodiments, the one or more wheels or castors has a tread configured to have sufficient traction to move the jet exhaust capture and containing apparatus in all weather conditions anticipated to be encountered at airports from the group consisting of rain, sleet, snow, ice, and extreme cold or hot temperatures.

In some embodiments, the one or more wheels or casters are configured with a size and made of a material of construction both configured to support catch basin, chute, drain plug, and container of the jet exhaust capture and containing apparatus when the container is empty or full of liquid slurry, while the jet exhaust capture and containment apparatus are in motion or still in all weather conditions anticipated to be encountered at airports from the group consisting of rain, sleet, snow, ice, and extreme cold or hot temperatures.

In some embodiments, the jet exhaust capture and containing apparatus further comprises a motor. The motor may be electric and may be in communication with a rechargeable battery. The motor may also be a small internal combustion engine. The motor is configured to be powerful enough to sufficiently move the jet exhaust capture and containing apparatus, empty or full of liquid slurry, anywhere while in operation in all weather conditions anticipated to be encountered at airports. This includes weather from a group consisting of rain, sleet, snow, ice, and extreme cold or hot temperatures.

In some embodiments, the apparatus further comprises one or more additional support arms connecting the catch basin to the container. The arms comprise a size configured to be large enough and a strength strong enough to hold the catch basin, empty or full of jet exhaust, while in motion or still. It also includes a durability, able to provide sufficient support or movement in all weather conditions anticipated to be encountered at airports from the group consisting of rain, sleet, snow, ice, and extreme cold or hot temperatures.

In some embodiments, apparatus further comprises a first element for drawing the ultrafine particles and gaseous exhaust through the chute and into the container. This first element is configured to provide enough power to pull any ultrafine particles through any jet engine or auxiliary power unit nozzle that is in operation, through the chute, and down to the container without possible damage to any part of the jet engine, auxiliary power unit, or jet exhaust capture and containing apparatus. The element is from a group consisting of at least one configuration that creates a gravity pull, a fan, a turbine, or a pump.

In some embodiments, the jet exhaust capture and containing apparatus further comprises a second element configured to draw some gaseous exhaust away from the ultrafine particles and into a filter housing containing a filter element capable of filtering to a particle size of four nanometers (nm) and through an exhaust vent at a low to zero-emission level and is from a group consisting of at least one of a configuration to create a fan, a turbine, or a pump. The UFP and gaseous exhaust produced by the jet engine or APU is filtered. The jet exhaust drawn into the catch basin and transported into the container via the chute stays until it becomes a liquid slurry component and a gaseous component. The gaseous component is drawn into a filter housing containing a filter element capable of filtering to a predetermined particle size and then passes through an exhaust vent at a low to zero UFP concentration level into the atmosphere. The removed UFP is returned to the liquid slurry component to remain until emptied (via a drain plug) for proper disposal or recycling. In one embodiment, the particle size filtered is ten (10) nanometers (nm), in some, it is eight (8) nm, in some, it is six (6) nm, in some, it is five (5) nm, in some it is four (4) nm, in some it is three (3) nm, in some it is two nm, and in some, it is less than two (2) nm. The filter size depends on many factors, including air quality restrictions, time restraints, and cost restraints.

In some embodiments, the jet exhaust capture and containing apparatus further comprises a third element configured to draw the liquid slurry out of the container through the drain plug for proper disposal or recycling. The third element is configured with a durability to permit operation in all weather conditions anticipated to be encountered at airports from the group consisting of rain, sleet, snow, ice, and extreme cold or hot temperatures and is from a group consisting of at least one of a configuration to create gravity and a pump within the container.

Two or more of the first element, the second element, and the third element may be the same.

In some embodiments of the jet exhaust capture and containing apparatus, the container further comprises an internal float or switch device configured to automatically activate when the level of liquid slurry occupies a sufficient volume of the container. An external visual indicator is triggered and shows an operator of the jet exhaust capture and containing apparatus when the container is full and in need of emptying. The device has a durability sufficient to operate in all weather conditions anticipated to be encountered at airports from the group consisting of rain, sleet, snow, ice, and extreme cold or hot temperatures conditions, including during rain, sleet, snow, and extreme cold or hot temperatures.

In some embodiments, the apparatus further comprises an external visual indicator configured to alert an operator of the apparatus when the apparatus needs to be emptied. The external visual indicator has a durability sufficient to operate in all weather conditions anticipated to be encountered at airports from the group consisting of rain, sleet, snow, ice, and extreme cold or hot temperatures.

In some embodiments, the apparatus further comprises a power button comprising security features. One security feature is to prevent unauthorized use or theft of the jet exhaust capture and containing apparatus. The security feature has a durability sufficient to operate in all weather conditions anticipated to be encountered at airports from the group consisting of rain, sleet, snow, ice, and extreme cold or hot temperatures.

In some embodiments, the apparatus further comprises a hood configured to assist in preventing ultrafine particles and gaseous exhaust from escaping into the atmosphere while the jet exhaust capture and containing apparatus is in use. It also has a durability sufficient to provide satisfactory support or movement in all weather conditions anticipated to be encountered at airports from the group consisting of rain, sleet, snow, ice, and extreme cold or hot temperatures.

In some embodiments, the jet exhaust capture and containing apparatus further comprises a source of illumination configured to guide the apparatus directly behind the jet engine or auxiliary power unit nozzle in low light conditions. This illumination source has a durability sufficient to operate in all weather conditions anticipated to be encountered at airports from the group consisting of rain, sleet, snow, ice, and extreme cold or hot temperatures.

In some embodiments, the apparatus further comprises a controller configured to permit the operation of the apparatus or any part thereof as needed. The controller has a durability sufficient to operate in all weather conditions anticipated to be encountered at airports from the group consisting of rain, sleet, snow, ice, and extreme cold or hot temperatures.

The invention may be further understood through the viewing of figures of an embodiment.

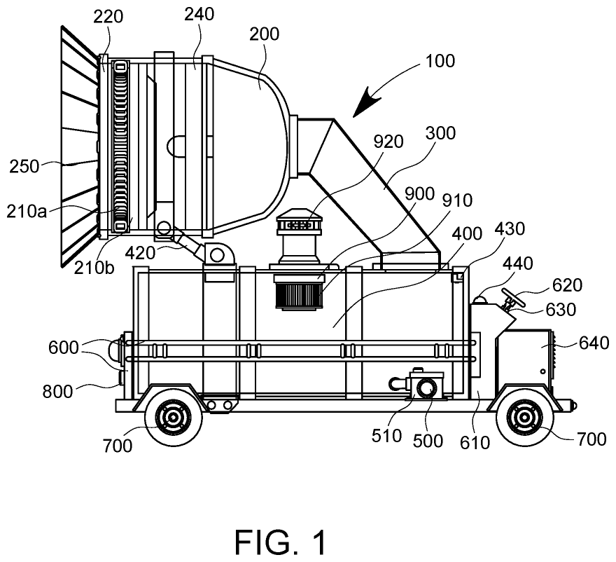

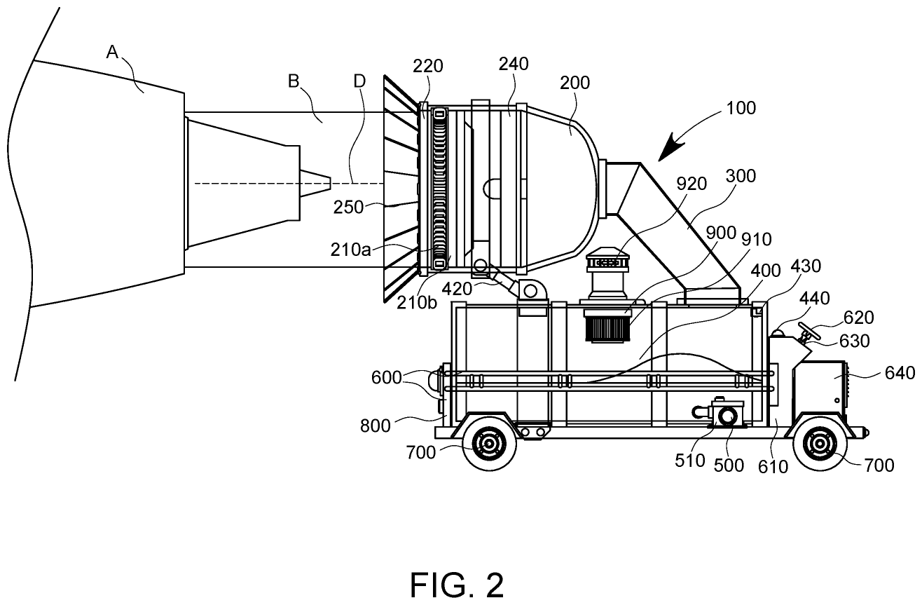

Referring to FIG. 1 and FIG. 2, FIG. 1 is a side view of one potential embodiment of an apparatus. An apparatus (100) is shown with a catch basin (200) with an electromagnetic element (210a), an insulating ring (210b), an intake orifice (220), an internal fan (240), and folding flaps (250). Catch basin 200 is attached to a chute (300) that is attached to a container (400). An adjusting arm (420) is attached to both catch basin 200 and container 400. Container 400 is also attached to an integrated level sensor (430) and a level indicating light (440). A drain plug (500) is attached to container 400 in communication with a pump (510). Container 400 is attached to a frame (600) that is attached to a controller (610), a direct steering mechanism (620), a power button (630), a battery (640), and headlamps (800). Frame 600 is also in communication with four wheels. Container 400 is also attached to the filter element (900) and exhaust vent (920). FIG. 2 is a side view of the apparatus shown in FIG. 1 and a partial jet engine with jet engine exhaust. Catch basin 200 of an apparatus 100 is lined up with the axis of a jet engine exhaust (C) of a jet engine (B). Apparatus 100 is shown with all the elements shown in FIG. 1.

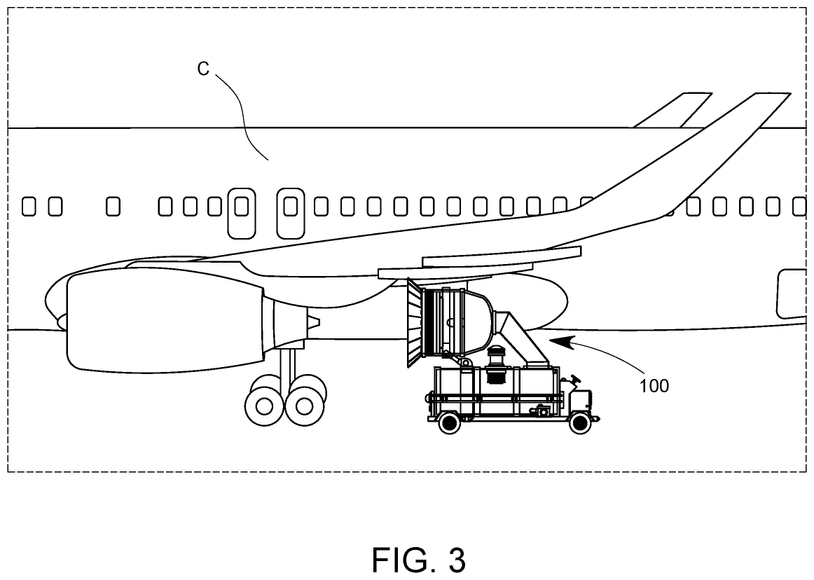

FIG. 3 is a side view of the apparatus shown in FIG. 1 and the entire jet engine with part of a jet. This gives a perspective of the relative size of the embodiment of apparatus 100 shown in FIG. 1 and a jet engine whose jet exhaust is being retrieved.

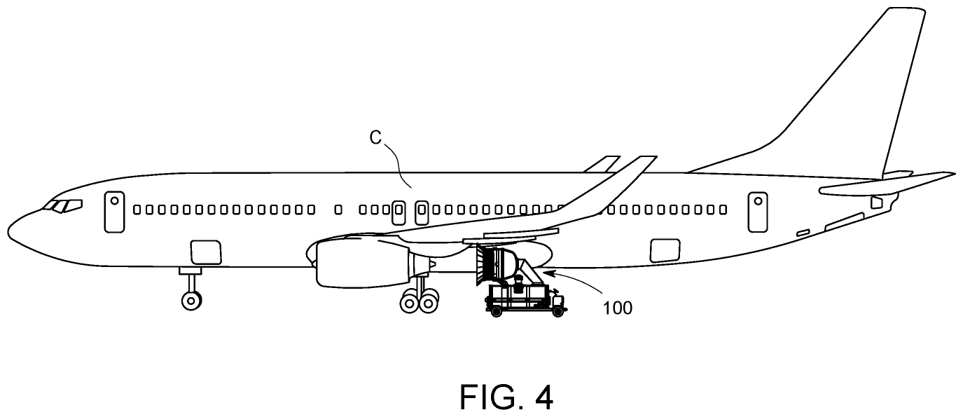

FIG. 4 is a side view of the apparatus shown in FIG. 1 and the entire jet and the embodiment of the apparatus shown in FIG. 1. This gives another perspective of the relative size of an embodiment of apparatus 100 and an entire jet t engine whose jet exhaust is being retrieved. The jet's size illustrates a relative comparison and may differ in size from smaller to larger in actual use.

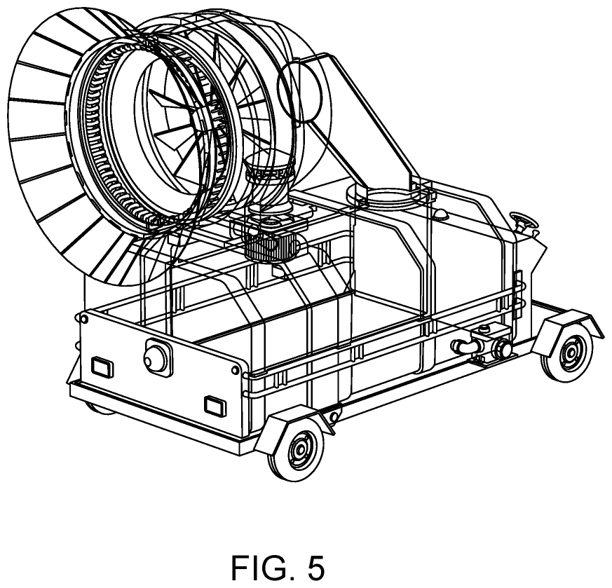

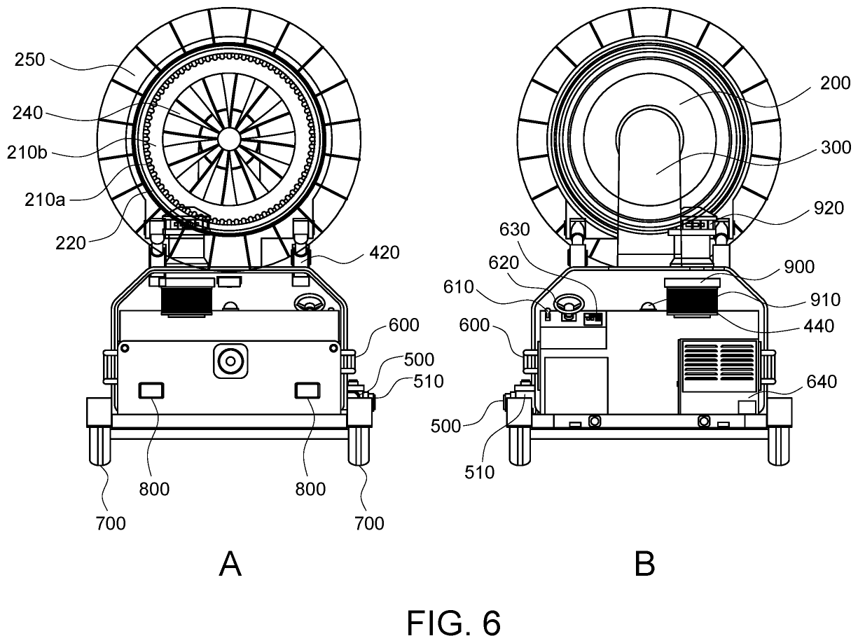

Referring to FIG. 5 and FIG. 6, FIG. 5 is a perspective view looking downward of the apparatus shown in FIG. 1 but without the container. FIG. 6 are two views of the apparatus shown in FIG. 1, showing the front (A) and back (B) of the apparatus. The front view shows more clearly the embodiments of electromagnetic element 210a, insulating ring 210b, intake orifice (220), internal fan 240, and folding flaps 250. The back view shows a different view of some elements.

The method aspect of using a jet exhaust capture and containing apparatus for collecting UFPs and gaseous exhaust exiting a jet engine or APU nozzle while the jet is in operation comprises four steps. The first step is providing a jet engine or APU in operation. The second step is providing a jet exhaust capture and containing apparatus as described above. The third step is collecting jet exhaust from the jet engine or auxiliary power unit in operation, converting it into a liquid slurry for storage in a safe and healthy manner. The fourth step is disposing of collected and converted liquid slurry in a safe and healthy manner.

In operation, UFPs and gaseous exhaust produced by the jet engine or APU is drawn into the catch basin and transported into the container via the chute, where the gaseous exhaust may be filtered and vented into the atmosphere at a low to zero-emission level, and the UFPs return to a liquid state and remain until emptied via a drain plug for proper disposal or recycling.

The invention may or may not be powered and may or may not be propelled by artificial means, and may or may not include a rechargeable battery and electric motor or small internal combustion engine as a means of propulsion. The invention may or may not have an additional support arm or arms connecting the catch basin to the container. In addition, the invention may or may not have a latching system within the catch basin allowing the invention to provide a secure seal to the jet engine or APU. The invention may or may not use gravity to draw the UFPs and gaseous exhaust into the container by the chute, or the invention, may or may not include a fan, turbine, pump, or other such suction device to help draw the UFPs and gaseous exhaust through the chute and into the container. The invention may have sensors close to or inside the collection bin or chute to monitor the amount and types of organophosphates esters and volatile organic compounds as well as natural compounds and metals within the UFPs and gaseous exhaust it is collecting, allowing the invention to determine what amount of said compounds are being removed from the surrounding environment in order to gauge its environmental impact. Also, the invention may include an air filtration system, using a carbon filtration element or other type of filtration element capable of filtering to a particle size in the range of typically about four (4) nanometers (nm), included to capture the gaseous exhaust emitted by the jet engine or APU in addition to the UFPs. The gaseous exhaust may be drawn through said air filtration system, purified, and exhausted as clear air through an exhaust vent located on the invention. This filtration system may also include a compressed air unit used to automatically or manually clean said filtration system periodically to keep it operating at maximum efficiency.

The invention may or may not use gravity to draw the collected UFPs converted into liquid slurry out of said invention via the drain plug for proper disposal or recycling. Alternatively, the invention may or may not use a pump within the container to draw the collected UFPs converted into liquid out of said invention via the drain plug for proper disposal or recycling. The invention may or may not have an internal float or switch triggering an external visual indicator to show operators of said invention when it is full and in need of emptying. Said invention may or may not have a power button that may or may not require a key or other such security to prevent unauthorized use or theft of said invention and may or may not be incorporated into a joystick, steering wheel, or other such means of control. The invention may include a shield or enclosure to protect the operator from any exhaust UFPs that may be escaping the collector if it has not been positioned or latched properly. The shield or enclose may have a wiper system with a liquid-filled washer system for cleaning any jet exhaust or other natural element such as rain, snow, or dirt from the shield or enclosure. The invention may have a platform for the operator to stand on, allowing the invention to follow the aircraft up to or onto the runway in order to capture as much emissions as possible prior to takeoff, or the invention may not have a platform for the operator to stand on, allowing the invention to be manually pushed into position and pulled away from position by the operator while the aircraft is within walking distance.

The invention may or may not have other elements to assist operation. It may or may not have a hood that may or may not have collapsible flaps intended to assist the latching system in preventing UFPs from escaping into the atmosphere while said invention is in use. It may or may not have a means of illumination that may or may not be on the front of said invention and may or may not be used in low light conditions to guide said invention directly behind the nozzle of a jet engine or APU. It may have sensors allowing the device to sense when the aircraft is moving and then automatically start, stop, or turn its movement in accordance with the aircraft. Finally, it may or may not include a joystick, steering wheel, or other such means of control for operating the invention, or any parts thereof, as described in this patent application.

As stated above, the invention includes a catch basin used to collect UFPs and gaseous exhaust. The catch basin should be sufficient in size to catch all UFPs and gaseous exhaust exiting a jet engine or APU nozzle and may or may not be made of metal, plastic, carbon fiber, rubber, vinyl, nylon, or other such similar material. Said catch basin may or may not have an intake orifice that is circular, square, rectangular, or of such similar shape. The catch basin may or may not have an intake orifice that is adjustable in diameter to allow said invention to be used behind a variety of jet engines or APUs. Finally, said catch basin should be durable enough to operate in all weather conditions, including during rain, sleet, snow, and in extreme cold or hot temperatures.

The Invention may include a latching system within the catch basin, allowing the invention to provide a secure seal to the jet engine or APU. Said latching system should be sufficient in size to create a secure seal around a variety of jet engines or APU nozzles.

Said latching system may connect to the jet engine or APU nozzle using suction or magnetic/electromagnetic attraction and may or may not be made of metal, plastic, carbon fiber, rubber, vinyl, nylon, or other such similar material. Finally, said catch basin should be durable enough to operate in all weather conditions, including during rain, sleet, snow, and in extreme cold or hot temperatures.

In addition, the invention includes a chute connecting the catch basin to the container. The chute should be sufficient in size to efficiently transport all UFPs and gaseous exhaust exiting a jet engine into the container without clogging itself or otherwise disrupting the flow of the UFPs and gaseous exhaust. The chute may or may not be rigid or flexible and may or may not be made of metal, plastic, carbon fiber, rubber, vinyl, nylon, or other such similar material. The chute may or may not be circular, square, rectangular, or of such similar shape. Finally, the chute should be durable enough to operate in all weather conditions, including during rain, sleet, snow, and in extreme cold or hot temperatures.

As stated above, the invention includes a container connected to the catch basin by the chute. The container should be sufficient enough in size to contain a predetermined amount UFPs and gaseous exhaust for a predetermined or reasonable amount of time before needing to be emptied. The container may or may not be made of metal, plastic, carbon fiber, rubber, vinyl, nylon, or other such similar material. Said container may or may not be circular, square, rectangular, or of such similar shape. Finally, said container should be durable enough to operate in all weather conditions, including during rain, sleet, snow, and in extreme cold or hot temperatures.

Also, as stated above, the invention includes a drain plug connected to the container as a means for emptying and properly disposing or recycling of the collected UFPs converted into liquid. The drain plug may or may not be made of metal, plastic, carbon fiber, rubber, vinyl, nylon, or other such similar material. Said drain plug may or may not be circular, square, rectangular, or of such similar shape. Finally, said drain plug should be durable enough to operate in all weather conditions, including during rain, sleet, snow, and in extreme cold or hot temperatures.

As stated above, the invention includes one or more wheel(s) or caster(s) connected to or in communication with the container. Said wheel(s) or caster(s) may or may not be pneumatic or solid and may or may not be on swivels allowing one or more of said wheel(s) or caster(s) to rotate a full 360 degrees and may or may not propel said invention with or without power. Said wheel(s) or caster(s) may or may not be made of metal, plastic, carbon fiber, rubber, vinyl, nylon, or other such similar material. Said wheel(s) or caster(s) should be large enough and strong enough to hold said invention, empty or full, while in motion or still. Finally, said wheel(s) or caster(s) should have tread to provide sufficient traction in all weather conditions, including during rain, sleet, and snow, as well as on ice and in extreme cold or hot temperatures.

The invention may or may not include a motor as a means of propulsion. The motor may be an electric motor or small internal combustion engine and, if electric, may include a battery that may be rechargeable or replaceable. Said motor should be powerful enough to move said invention, empty or full, while in motion or from a still location. Finally, the motor should have enough power to provide adequate movement for the task at hand in all weather conditions, including during rain, sleet, and snow, as well as on ice and in extreme cold or hot temperatures.

The invention may or may not include an additional adjustable support arm or arms connecting the catch basin to the container. The support arm or arms may or may not operate with or without power, manually or electronically, raise, lower, or rotate the catch basin as desired, autonomously or by the use of a joystick, steering wheel, or other such means of control. The support arm or arms may or may not be made of metal, plastic, carbon fiber, rubber, vinyl, nylon, or other such similar material. In addition, the support arm or arms should be large enough and strong enough to hold said invention's catch basin, empty or full, while in motion or still. Finally, the support arm or arms should be durable enough to provide sufficient support or movement in all weather conditions, including during rain, sleet, snow, and in extreme cold or hot temperatures.

Also, the invention may or may not use gravity to draw the UFPs and gaseous exhaust into the container via the chute, or the invention, may or may not include a fan, turbine, pump, or other such suction device to help draw the UFPs and gaseous exhaust through the chute and into the container. The fan, turbine, pump, or other such suction device may or may not turn on automatically when said invention is started, may or may not be turned on manually by an operator, or may or may not turn on electronically when it senses UFPs or gaseous exhaust entering the catch basin. The fan, turbine, pump, or other such suction device may or may not provide enough power to pull UFPs and gaseous exhaust through any jet engine turbine or APU in operation through the chute and down to the container without possible damage to any part of the jet engine, APU or said invention. Also, the fan, turbine, pump, or other such suction device may or may not be placed in or on the catch basin, chute, or container. The fan, turbine, pump, or other such suction device may be made of metal, plastic, carbon fiber, rubber, vinyl, nylon, or other such similar material. Finally, the fan, turbine, pump, or other such suction device should be durable enough to operate in all weather conditions, including during rain, sleet, snow, and in extreme cold or hot temperatures.

In addition, the invention may or may not include an element, such as an additional fan, turbine, pump, or other such suction device for first drawing some gaseous exhaust away from the UFPs and into a filter housing containing a filter element capable of filtering to a particle size of four (4) nanometers (nm) and second through an exhaust vent at a low to zero-emission level. The element, such as an additional fan, turbine, pump, or other such suction device (1) may or may not turn on automatically when said invention is started, (2) may or may not be turned on manually by an operator, or (3) may or may not turn on electronically when it senses UFPs or gaseous exhaust entering the catch basin, chute or container. Also, the additional fan, turbine, pump, or other such suction device may or may not be placed in the container. The additional fan, turbine, pump, or other such suction device may be made of metal, plastic, carbon fiber, rubber, vinyl, nylon, or other such similar material. Finally, said additional fan, turbine, pump, or other such suction device should be durable enough to operate in all weather conditions, including during rain, sleet, snow, and in extreme cold or hot temperatures.

In addition, the invention may or may not use gravity to draw the collected UFPs converted into liquid out of said invention via the drain plug for proper disposal or recycling or said invention may or may not use a pump within the container to draw the collected UFPs converted into liquid out of said invention via the drain plug for proper disposal or recycling. The pump may or may not be turned on manually by an operator or may or may not turn on automatically when said invention's drain plug is removed. Finally, said pump should be durable enough to operate in all weather conditions, including during rain, sleet, snow, and in extreme cold or hot temperatures.

The invention may or may not have an internal float or switch triggering an external visual indicator to show operators of said invention when it is full and in need of emptying. The internal float or switch should activate automatically when the level of UFPs converted into liquid occupies a sufficient volume of the container and notify said invention's operator via an external indicator. Finally, the internal float or switch should be durable enough to operate in all weather conditions, including during rain, sleet, snow, and in extreme cold or hot temperatures.

The invention may or may not have an external visual indicator to alert said invention's operator when said invention needs to be emptied. The external visual indicator may or may not be a light-emitting diode or other such similar light source and may or may not flash any color or white light. Finally, said external visual indicator should be durable enough to operate in all weather conditions, including during rain, sleet, snow, and in extreme cold or hot temperatures.

Moreover, the invention may or may not have a power button that may or may not require a key or other such security to prevent unauthorized use or theft of said invention and may or may not be incorporated into a joystick, steering wheel, or other such means of control. The power button may or may not be illuminated by a light emitting diode or other such similar light source and may or may not stay illuminated when said invention is in operation. Finally, said power button should be durable enough to operate in all weather conditions, including during rain, sleet, snow, and in extreme cold or hot temperatures.

As previously stated, the invention may or may not have a hood that may or may not have flaps intended to assist the latching system in preventing UFPs or gaseous exhaust from escaping into the atmosphere while said invention is in use. Said hood that may or may not have flaps may or may not operate with or without power, raise, lower, tilt in any direction, or collapse for storage, manually or by the use of a joystick, steering wheel, or other such means of control. The hood that may or may not have flaps may be made of metal, plastic, carbon fiber, rubber, vinyl, nylon, or other such similar material. The hood that may or may not have flaps should be adjustable and expandable enough or collapsible enough to prevent UFPs or gaseous exhaust from escaping into the atmosphere from a variety of jet engines or APU sizes while said invention is in use. Said hood that may or may not have flaps may be made of metal, plastic, carbon fiber, rubber, vinyl, nylon, or other such similar material. Finally, said hood that may or may not have flaps should be durable enough to provide sufficient support or movement in all weather conditions, including during rain, sleet, snow, during windy conditions, and in extreme cold or hot temperatures.

The invention may or may not have a means of illumination that may or may not be on the front of said invention and may or may not be used in low light conditions to guide said invention directly behind the nozzle of a jet engine or APU. The external means of illumination may or may not be one or more light-emitting diode(s) or other such similar light source and may or may not produce any color or white light. Finally, said means of illumination should be durable enough to operate in all weather conditions, including during rain, sleet, snow, and in extreme cold or hot temperatures.

The invention may have sensors allowing the device to sense when the aircraft is moving and then automatically start or stop its movement in accordance with the aircraft or may or may not include a joystick, steering wheel, or other such means of control for operating said invention, or any parts thereof, as described above. The joystick, steering wheel, or other such means of control may or may not control said invention, or any parts thereof, using mechanical means. The joystick, steering wheel, or other such means of control may or may not control said invention, or any parts thereof, using electrical or electronic means. The joystick, steering wheel, or other such means of control may or may not be made of metal, plastic, carbon fiber, rubber, vinyl, nylon, or other such similar material. Finally, said joystick, steering wheel, or other such means of control should be durable enough to operate in all weather conditions, including during rain, sleet, snow, and in extreme cold or hot temperatures.

### LIST OF COMPONENTS

A=Jet Engine, B=Jet Exhaust, C=Jet, D=Jet Exhaust Axis, 100=Apparatus, 200=Catch Basin, 210a=Electromagnets, 210b=Insulating Ring, 220=Intake Orifice, 240=Internal Fan, 250=Folding Flaps, 300=Chute, 400=Container, 420=Adjustable Arm, 430=Integrated Level Sensor, 440=Level Indicating Light, 500=Drain Plug, 510=Pump, 600=Frame, 610=Controller, 620=Direct Steering, 630=Power Button, 640=Battery, 700=Wheels, 800=Headlamps, 900=Filter Housing, 910=Filter Element, 920=Exhaust Ven.

I claim:

1. A jet exhaust capture and containing apparatus for collecting ultrafine particles and gaseous exhaust exiting a jet engine or jet auxiliary power unit nozzle along an axis while in operation, comprising:
a catch basin comprising an adjustable intake orifice, a size sufficient to capture the ultrafine particles and gaseous exhaust, a diameter configured to allow the jet exhaust capture and containing apparatus to be used behind a variety of jet engines or auxiliary power unit nozzles, and an exit end,
a chute comprising a first end connected to the exit of the catch basin, a size configured to efficiently transport all ultrafine particles and gaseous exhaust exiting a jet engine or auxiliary power unit nozzle without clogging itself or otherwise disrupting the flow of the ultrafine particles and gaseous exhaust through the adjustable chute, and an exit end,
a container comprising a front end connected to the exit end of the adjustable chute, a size configured to be sufficient to contain a predetermined amount of ultrafine particles and gaseous exhaust for a predetermined or reasonable amount of time to allow the ultrafine particles and gaseous exhaust to convert into a liquid slurry before needing to be emptied from the container, a material of construction, and an end,
a drainage plug configured to connect to the exit end of the container and be used for emptying and properly disposing or recycling of the liquid slurry,
a frame configured to support the container, and
one or more wheels or casters connected to the frame and configured to provide mobility to transport the jet exhaust capture and containing apparatus to and from a jet engine or auxiliary power unit nozzle while the jet engine or auxiliary power unit is in operation.

2. The jet exhaust capture and containing apparatus of claim 1 wherein the adjustable intake orifice of the catch basin is configured to tilt up, down, right, or left up to 60 degrees about the axis of the jet exhaust under manual or motorized control and the chute is configured to rotate a full 360 degrees about the axis of the jet exhaust under manual or motorized control and lower as low as 0 degrees or raise as high as 160 degrees about the axis of the jet exhaust under manual or motorized control.

3. The jet exhaust capture and containing apparatus of claim 1 wherein the container is small or compact enough to allow the apparatus to be placed where needed.

4. The jet exhaust capture and containing apparatus of claim 1 wherein the size of the container is large or open enough to contain all ultrafine units and gaseous exhaust exiting the jet engine or auxiliary power unit nozzle for a predetermined amount of amount of time of at least 2 hours.

5. The jet exhaust capture and containing apparatus of claim 1 wherein the material of construction of the frame is strong enough to hold the container, and the container is strong enough to hold the catch basin, chute, and drain plug of the jet exhaust capture and containing apparatus when the container is empty or full of liquid slurry and while the jet exhaust capture and containment apparatus is in motion or still.

6. The jet exhaust capture and containing apparatus of claim 1 wherein the wheel has a tread configured to have sufficient traction to move the jet exhaust capture and containing apparatus in all weather conditions anticipated to be encountered at airports from the group consisting of rain, sleet, snow, ice, and extreme cold or hot temperatures.

7. The jet exhaust capture and containing apparatus of claim 1 wherein the intake orifice of the catch basin further comprises a latching system within the catch basin allowing the catch basin to provide a secure seal to the jet engine or auxiliary power unit nozzle for various sized jet engines and auxiliary power unit nozzles in a variety of weather conditions anticipated to be encountered at airports from a group consisting of rain, sleet, snow and in extreme cold or hot temperatures.

8. The jet exhaust capture and containing apparatus of claim 1 wherein the one or more wheels or casters are configured with a size and made of a material of construction both configured to support catch basin, chute, drain plug, and container of the jet exhaust capture and containing apparatus when the container is empty or full of liquid slurry, while the jet exhaust capture and containment apparatus is in motion or still in all weather conditions anticipated to be encountered at airports from the group consisting of rain, sleet, snow, ice, and extreme cold or hot temperatures.

9. The jet exhaust capture and containing apparatus of claim 1 further comprising:
a motor in communication with at least the container comprising a rechargeable battery and electric motor or small internal combustion engine configured to be powerful enough to sufficiently move the jet exhaust capture and containing apparatus, empty or full of liquid slurry, anywhere while in operation in all weather conditions anticipated to be encountered at airports from the group consisting of rain, sleet, snow, ice, and extreme cold or hot temperatures.

10. The jet exhaust capture and containing apparatus of claim 1 further comprising:
one or more additional support arms connecting the catch basin to the container comprising a size configured to be large enough and a strength strong enough to hold the catch basin, empty or full of jet exhaust, while in motion or still, and a durability able to provide sufficient support or movement in all weather conditions anticipated to be encountered at airports from the group consisting of rain, sleet, snow, ice, and extreme cold or hot temperatures.

11. The jet exhaust capture and containing apparatus of claim 1 further comprising:
a first element for drawing the ultrafine particles and gaseous exhaust through the chute and into the container that is configured to provide enough power to pull any ultrafine particles through any jet engine or auxiliary power unit nozzle that are in operation and through the chute and down to the container without possible damage to any part of the jet engine, auxiliary power unit, or jet exhaust capture and containing apparatus, and is from a group consisting of at least one of a configuration to create gravity, a fan, a turbine, or a pump.

12. The jet exhaust capture and containing apparatus of claim 1 further comprising:
a second element for drawing some gaseous exhaust away from the ultrafine particles and into a filter housing containing a filter element capable of filtering to a particle size of four nanometers (nm) and through an exhaust vent at a low to zero-emission level and is from a group consisting of at least one of a configuration to create a fan, a turbine, or a pump.

13. The jet exhaust capture and containing apparatus of claim 1 further comprising:
a third element configured to draw the liquid slurry out of the container through the drain plug for proper disposal or recycling, the element is configured with a durability to permit operation in all weather conditions anticipated to be encountered at airports from the group consisting of rain, sleet, snow, ice, and extreme cold or hot temperatures and is from a group consisting of at least one of a configuration to create gravity and a pump within the container.

14. The jet exhaust capture and containing apparatus of claim 1 further comprising:
an internal float or switch device in communication with the container and configured to automatically activate when the level of liquid slurry occupies a sufficient volume of the container and trigger an external visual indicator to show an operator of the jet exhaust capture and containing apparatus when it is full and in need of emptying, and have a durability sufficient to operate in all weather conditions anticipated to be encountered at airports from the group consisting of rain, sleet, snow, ice, and extreme cold or hot temperatures conditions, including during rain, sleet, snow, and extreme cold or hot temperatures.

15. The jet exhaust capture and containing apparatus of claim 1 further comprising
an external visual indicator in communication with the container to alert an operator of the jet exhaust capture and containing apparatus when the container needs to be emptied, and have a durability sufficient to operate in all weather conditions anticipated to be encountered at airports from the group consisting of rain, sleet, snow, ice, and extreme cold or hot temperatures.

16. The jet exhaust capture and containing apparatus of claim 1 further comprising:
a power button comprising a security feature to prevent unauthorized use or theft of the jet exhaust capture and containing apparatus and a durability sufficient to operate in all weather conditions anticipated to be encountered at airports from the group consisting of rain, sleet, snow, ice, and extreme cold or hot temperatures.

17. The jet exhaust capture and containing apparatus of claim 1 further comprising:
a hood configured to assist in preventing ultrafine particles and gaseous exhaust from escaping into the atmosphere while the jet exhaust capture and containing apparatus is in use and have a durability sufficient to provide satisfactory support or movement in all weather conditions anticipated to be encountered at airports from the group consisting of rain, sleet, snow, ice, and extreme cold or hot temperatures.

18. The jet exhaust capture and containing apparatus of claim 1 further comprising:
a source of illumination configured to guide said invention directly behind the jet engine or auxiliary power unit nozzle in low light conditions and have a durability sufficient to operate in all weather conditions anticipated to be encountered at airports from the group consisting of rain, sleet, snow, ice, and extreme cold or hot temperatures.

19. The jet exhaust capture and containing apparatus of claim 1 further comprising:
a controller configured to permit operation of the jet exhaust capture and containing apparatus, or any part thereof as needed, and have a durability sufficient to operate in all weather conditions anticipated to be encountered at airports from the group consisting of rain, sleet, snow, ice, and extreme cold or hot temperatures.

20. A method of using a jet exhaust capture and containing apparatus for collecting ultrafine particles and gaseous exhaust exiting from a jet engine or auxiliary power unit nozzle in operation near a building housing people or any other part of an airport property where an aircraft is in motion, or at a stop, around any part of an airport property where an aircraft may taxi, stop, or otherwise be in motion, the method comprising the steps of:
providing a jet engine in operation near a building containing people or where an aircraft is in motion, or at a stop, around any part of an airport property where an aircraft may taxi, stop, or otherwise be in motion;
providing a jet exhaust capture and containing apparatus comprising:
a catch basin comprising an adjustable intake orifice, a size sufficient to capture the ultrafine particles and gaseous exhaust, a diameter configured to allow the jet exhaust capture and containing apparatus to be used behind a variety of jet engines or auxiliary power unit nozzles, and an exit end;
a chute comprising a first end connected to the exit of the catch basin, a size configured to efficiently transport all ultrafine particles and gaseous exhaust exiting the jet engine or auxiliary power unit nozzle without clogging the adjustable chute or otherwise disrupting the flow of the ultrafine particles and gaseous exhaust through the chute, and an exit end,
a container comprising a front end connected to the exit end of the adjustable chute, a size configured to be small or compact enough to be placed where needed and large or open enough to sufficiently contain a predetermined amount of ultrafine particles and gaseous exhaust for a predetermined or reasonable amount of time to allow the ultrafine particles and gaseous exhaust to convert into a liquid slurry before needing to be emptied from the container, and an end,
a drainage plug configured to connect to the exit end of the container and be used for emptying and properly disposing or recycling of the liquid slurry,
a frame configured to support the container, and
one or more wheels or casters connected to the container and configured to provide mobility to transport the exhaust capture and containing apparatus to and from the operating jet engine or auxiliary power unit nozzle while in motion or at stop;
collecting ultrafine particles and gaseous exhaust from the jet engine or auxiliary power unit in operation and convert ultrafine particles and gaseous exhaust into a liquid slurry for storage in a safe and healthy manner; and
disposing of collected and converted liquid slurry in a safe and healthy manner.
